(19) United States
(12) Patent Application Publication
(10) Pub. No.: US 2004/0236707 A1
(43) Pub. Date: Nov. 25, 2004

(54) Portable mailing system

(75) Inventor: Tom E. Lingdell, Naugatuck, CT (US)

Correspondence Address: Thomas F. Presson, Pitney Bowes Inc., Intellectual Property & Technology Law Department, P.O. Box 3000, Shelton, CT, 06484-8000, US

(73) Assignee: Pitney Bowes Incorporated, Stamford, CT

(21) Appl. No.: 10/442,828

(22) Filed: May 21, 2003

(51) Int. Cl. G06F 17/60

(52) U.S. Cl. 705/402

(57) ABSTRACT

A method and apparatus for processing articles including collecting article information from a plurality of articles at associated locations of the articles. At the associated location, a class of service and a carrier is selected for the article. An article profile is generated as a function of the selected class of service and selected carrier. A label including the article profile information is then printed at the associated location. Information about one or more articles can be transmitted to a local storage location, or to a carrier location. The information collected from the plurality of articles will enable carriers in providing suitable equipment or personnel for the shipment of the articles.

### FIELD OF THE INVENTION

This invention relates generally to a method and apparatus for a portable system capable of processing articles that are to be shipped. More specifically, this invention relates to a portable processing system that determines rates for articles based on the weight of the article, the dimensions of the article, a selected class of service and a carrier.

### BACKGROUND DISCUSSION

Conventional systems for processing articles, such as mail pieces, packages, parcels, postcards, and the like, that are to be shipped, typically require the user to take the article to a centralized location to have the article processed. The centralized location is typically a mailroom within an organization, or a post office that have the necessary equipment. Such locations typically process high volumes of articles from various senders that will be sent to various recipients by different carriers.

When using a conventional article processing system, high volumes of articles can lead to difficulties in sorting, managing, and tracking the articles. Additionally, different mailrooms within a single building may have different methods for processing information of particular articles. When a particular delivery person comes to a building to collect articles for shipment from different mailrooms, the delivery person may not have received the same information from each mailroom. If the delivery person does not receive adequate information regarding articles to be shipped, the carrier may not be able to accommodate the entire shipment from the building. For example, a large shipment may require a larger vehicle or additional personnel to transport it. Also, the delivery person may be able to use a smaller vehicle or make additional pick-ups if a small shipment is being sent.

An example of a conventional system includes U.S. Pat. No. 5,337,246, entitled, “Flexible Apparatus and Method for Applying Customized Rating Adjustments to Transaction Charges,” which relates to a method and a system for enabling an authorized user of the system to automatically apply customized rating adjustments to transaction charges. A structure is employed for supplying information identifying criteria for rating and for customized rating adjustments to a central processor. The central processor compares data entered through an input device with information stored in memory. The central processor, after correlating the identifying information with the entered input data, generates a base rate and a modified rate for a particular transaction and user. The calculated charges are then made available to the user. One drawback to this system is that it is not portable. Therefore, it cannot be transported to a user's location.

Another example of a conventional system used in mailrooms and post offices is U.S. Pat. No. 4,524,426, entitled “Electronic Postage Meter Controllable by Mailing Machine,” which relates to a postage meter system that includes a postage meter in a secure housing. The secure housing encloses an electronic accounting system having registers and a printer. All control for the postage meter is effected by way of a connector on the housing for connecting a mailing machine or service unit to the postage meter. In operation, a sole input to the meter is by way of a keyboard of the mailing machine and a sole signal output is to the mailing machine to a display. The postage meter has a program to continuously read out its registers to the connector upon an initial application of power to the connector and a service unit which may be adapted solely to display such signals. A similar drawback exists with this invention in that it is not easily portable.

It would be advantageous to have a portable system for processing articles for shipment. When an article is picked up at a user's location, the article will be processed and prepared for shipment.

### BRIEF SUMMARY OF THE INVENTION

To overcome the drawbacks of the prior art, the instant invention utilizes wireless communication technology and a portable mailing machine.

Accordingly, one embodiment of the present invention is directed to a method of processing articles at the location of each article. The method includes collecting article information from each article processed. A class of service and a carrier are selected for the article. An article profile is generated as a function of the article information, the selected class of service and the carrier. A label including the article profile information is then printed.

Another embodiment of the present invention is directed to a packaging process. The process includes transporting a portable package processing unit to a location of an article. At the location of the article, information relating to the article is collected. A class of service and a carrier is then selected for the article. A label is printed for the article. Finally, the article is sorted or grouped based on the selected carrier.

Yet another embodiment of the present invention is directed to a portable apparatus for processing articles. The apparatus includes a portable scale that weighs an article. A portable scanner determines dimensions of the article. A portable processing unit receives input from the scale and the scanner as well as class of service input and carrier selection input. The portable processing unit generates an output as a function of the mass, dimensions, selected class of service and a selected carrier for the article. A portable printer is coupled to the portable processing unit. The portable printer receives input, which includes the output from the portable processing unit. The portable printer outputs data that is a function of the input received from the portable processing unit.

Yet another embodiment of the present invention is directed to an apparatus for processing articles. The apparatus has means for collecting article information from each article at an associated location of the article. Also included are means for selecting a class of service and a carrier for the article at the associated location. Additionally, the apparatus has means for generating an article profile as a function of the collected article information. Furthermore, the apparatus has means for printing a label that includes the article profile information, wherein the printing is performed at the associated location.

### BRIEF DESCRIPTION OF THE DRAWINGS

Generally, FIGS. 1 through 4 show a portable mailing machine apparatus and portable mailing process.

FIG. 1 shows a portable mailing machine that can be transported to different locations.

FIG. 2 shows a block diagram of the portable processing unit in communication with a central location that is connected to a plurality of carriers.

FIG. 3 shows a block diagram of the portable processing unit coupled to a plurality of carriers.

FIG. 4 is a flowchart of the portable mailing system process.

### DETAILED DESCRIPTION OF THE INVENTION

The present invention overcomes some of the problems that are associated with traditional mailrooms. Use of traditional mailrooms and drop-off locations to ship articles through carriers such as United Parcel Service, United States Postal Service (USPS), Federal Express (FedEx), DHL, and other parcel and package transportation organizations, suffer from problems such as inconvenience and inefficiency.

The present invention enables information about articles, including mail pieces, packages, parcels, postcards, letters, business reply envelopes, self mailers, catalogs, brochures, etc., for shipment, to be acquired without transporting the article to the company's or building's mailroom, post office, or carrier drop-off location. This invention allows the mailroom to come to the user via a portable shipping system. Thus, inconvenience, disorganization, and inefficiency are no longer problems since articles to be mailed are processed and sorted before they even arrive at the mailroom or common repository location.

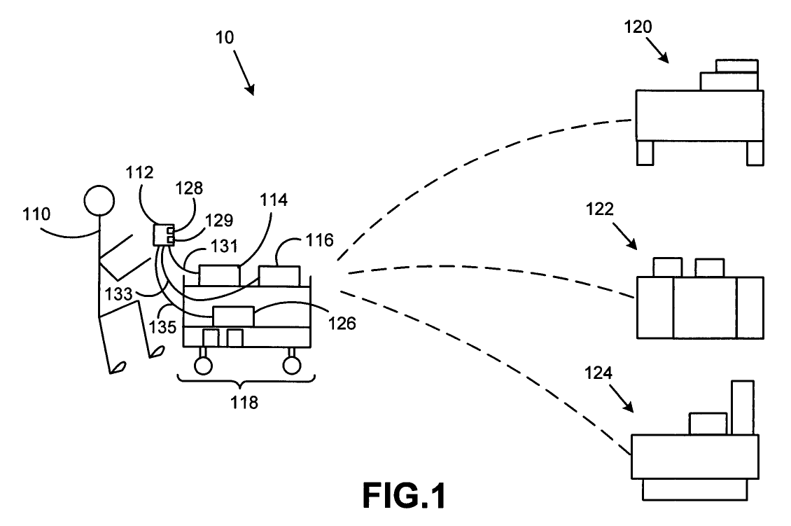

Referring to FIG. 1, system 10 shows a person 110 using system 118. The person 110 is typically an employee of a carrier such as UPS, FedEx, DHL, USPS, etc., or alternatively could be an internal employee of the organization or company sending the articles or other third party person who manages article collection and/or article organization. System 118 is shown on a wheeled cart. In the alternative, system 118 could also be adapted to be used with a backpack, a wheeled bag, a kiosk, or any device that would allow system 118 to be transported to, or located near, articles to be sent.

System 118 includes an electronic device 112, a scale 114, a scanner 116, and a printer 126. Electronic device 112 enables the person 110 to obtain article information. Article information includes mass, volume, recipient information, sender information, carrier information, service selection and any other information relating to the article provided by the mailer. The information may be in a bar code or other machine-readable code, that can be scanned by the user using the electronic device 112. Electronic device 112 could be for example, a handheld electronic tablet, a wireless electronic tablet computer, a laptop computer, a notebook computer, a personal digital assistant (PDA) such as a Palm® or Blackberry®, or any device with sufficient memory and processing capability and network access that can obtain and process article information. The electronic device 112 typically has a battery power source to provide electrical power to the device. Electronic device 112 contains processor 128 that receives and manipulates article information. Port 129 is typically a wireless network connection or RJ11 telephone jack or other I/O port capable of transmitting and receiving data. This transmission may be either over a wireless network, LAN, WAN, Intranet, Internet, or other network.

In one embodiment, article information is inputted manually by person 110 into the electronic device 112. This may be done by a touch screen user interface, stylus, or keyboard on the device 112. (Stylus and keyboard not shown). In an alternative embodiment, article information is received by the device 112 via a bi-directional communication link 131 between electronic device 112 and the scale 114, and a bi-directional link 133 between the electronic device 112 and the scanner 116. These bi-directional links may be a wire or other medium. In yet another alternative, electronic device 112 receives article information through a wireless connection with scale 114, scanner 116, and/or additional components that may have a wireless connection with electronic device 112. This information may be stored in the portable system 118, or transmitted and stored at a remote memory, either at the location or at a carrier location. The articles may include a combination of coded information and information obtained by the person 110 using the components of the portable mailing system.

The electronic device 112 is also in communication with printer 126 via bi-directional transmission medium 135. This enables the printer to output data received from the electronic device 112. The system 118 is typically powered by a power supply, such as a DC power supply or battery (not shown) or other portable power supply. The power supply is adapted to provide electrical power to the components of the system 118.

One skilled in the art will appreciate that system 118 has the ability to utilize more or less components than those shown in FIG. 1. For example, printer 126 may not be necessary in an embodiment in which the data is stored in a memory, either in electronic device 112, or in a remote memory location. Also, scanner 116 may not be necessary in an embodiment in which dimensional data is not desired.

In FIG. 1, system 118 is shown, being transported to three different locations: 120, 122, and 124. Locations 120, 122, and 124 may be a mailroom in a building, a post office, a central repository, an authorized carrier drop-off location, or other area that receives articles to be shipped. The locations 120, 122, and 124 may be in one building or in different buildings. Although only three locations are shown in FIG. 1, any number of locations is possible. Thus, the system 118 may be transported to the location of the article that is to be shipped.

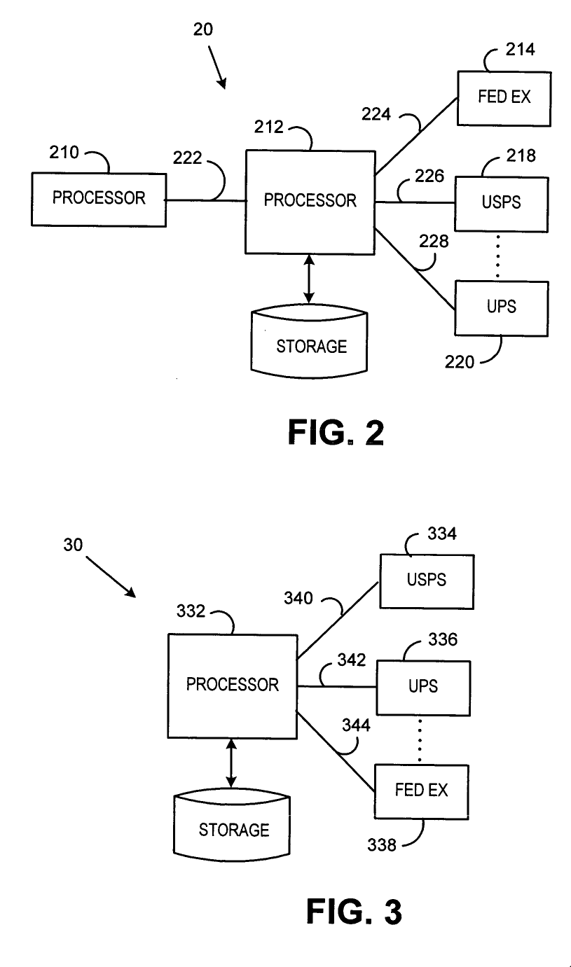

FIG. 2 shows a block diagram 20 of network interconnections. A processor 210, which is shown as electronic device 112 in FIG. 1, is coupled to a central database, or central server 212, which has processing and storage capability, via a bi-directional communication link 222. The central database 212 is typically located in, or is in communication with, a mailroom, post office, or other central repository location, that the article will ultimately be distributed from or database that is designated. The central database 212 may be connected to remote servers of a plurality of carrier locations 214, 218, and 220 though bi-directional communication links 224, 226, and 228, respectively. The connection could be a LAN (local area network), a WAN (wide area network), Internet, Intranet, or other network.

Bi-directional communication links 224, 226, and 228 can be a wireless connection, a cable modem, a 56K modem, a telephone connection, or any connection that provides two-way communication between the central database 212 and the carrier locations 214, 218, and 220. For illustrative purposes, central database 212 is connected to three carrier locations 214, 218, and 220, however those skilled in the art will appreciate that central database 212 can be connected to any number of carrier locations. The carrier locations 214, 218, and 220 are typically electronic memory devices, such as computers, databases, or servers that are capable of storing electronic data transmitted from database 212. The servers or database or computers are adapted to transmit data from the location 214, 218, 220, to a desired location for additional processing and/or manipulation.

Thus, the processor 210 is adapted to transmit data to a local database, or server, or storage and processing system, 212, which can then transmit the data to remote databases, servers, or storage and processing systems, 214, 218, 220. The data can be used at the local database 212 to determine if special actions must be taken for certain articles such as oversized or heavy packages, etc. Furthermore, the remote databases 214, 218, 220 are adapted to store and process the information such that the carrier can make any necessary pick-up modifications.

FIG. 3 shows a block diagram 30 of a system with various network connections. A processor 332 is, for example, used to obtain article information at the location of the article (FIG. 1), coupled via wireless communication links 340, 342, and 344 to carrier locations 334, 336, and 338. This embodiment allows the article information to be transmitted directly from the processor 332 to the carrier's location 334, 336, 338. Thus, the carriers receive information relating to article shipments such that the particular carriers can allocate resources for pickup based on the information received at the initial package processing stage. For example, if there is a large quantity of packages or articles, the carrier can send a larger vehicle or make other arrangements to accommodate the increased volume.

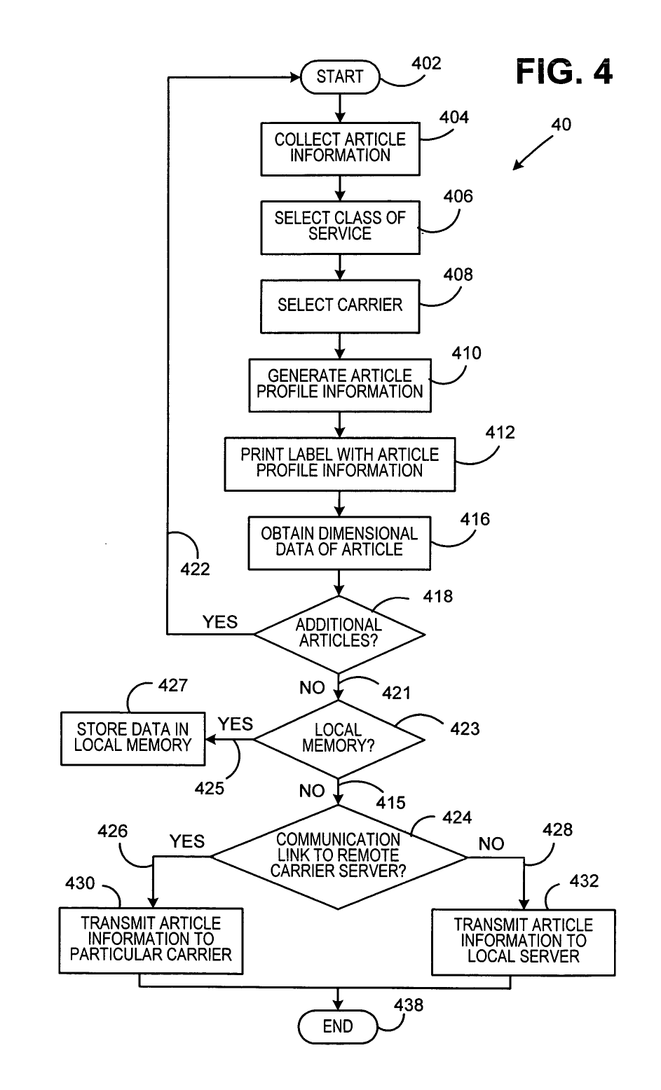

FIG. 4 is a flow chart 40 illustrating the flow of article information through the portable mailing machine system of the present invention. This process is typically stored on a computer readable medium, hardware, or software. The process starts in block 402. Block 404 shows that article information is collected and stored in a memory. This may be accomplished by using an electronic device such as a handheld processing tablet, a wireless notebook computer, a laptop computer, a personal digital assistant, or any device that has sufficient memory and processing capability. Such information may include article mass, recipient information, sender information, dimension data, quantity data, special handling data, and any other information relevant to processing the article for shipment.

A class of service is selected for the article at block 406. Classes of service for articles may include parcel post, overnight delivery, express delivery, priority, two-day delivery, certified, return receipt requested, first class, or any class of service the mailer requires. In block 408, a carrier is selected for the article. Examples of carriers that can be selected include for example, FedEx, Airborne Express, UPS, USPS, or DHL.

Once a carrier is selected, at step 410 article profile information is generated for each article processed. This is typically accomplished by an algorithm stored on the electronic device, software, hardware, or other programmable medium. In step 412, a label with the article profile information is printed. In step 416 dimensional data of the article is obtained. The dimensional data is obtained by scanning the article and providing its measurements to the processor.

Alternatively, the dimensional data can be obtained prior to the printing step 412, and included on the label. The embodiment shown in FIG. 4 shows that the dimensional data is obtained and transmitted to a storage location for use by the carrier.

Decision block 418 determines if there are any additional articles that need to be processed. If the answer is yes, line 422 shows that the process starts again at block 402 for each remaining article. If there are no additional articles, line 421 shows that in block 423 a determination is made whether there is a link to a local memory. Local memory may be a memory location associated with the data gathering process and may be remote from the apparatus. The local memory location may be in the building or central repository location. If there is a local memory, line 425 shows that in block 427 that the data is stored in the local memory.

If it is determined that there is not a local memory in decision block 423, line 415 shows that in block 424 a determination is made whether there is a communication link from the processor to the remote carrier location. If there is, line. 426 leads to block 430 where the dimensional data and article profile information are transmitted to a particular carrier. If there is not a link from the processor to a remote carrier server, line 428 leads to block 432 where dimensional data and article profile information are transmitted to a local server. Once the information and data has been transmitted to the appropriate server, the process is completed as shown by end block 438.

While the applicant has attempted to describe all of the possible embodiments that applicant has foreseen, there may be unforeseeable and insubstantial modifications that remain as equivalent.

What is claimed is:

1. A method for processing articles, comprising:
collecting article information from each of a plurality of articles at an associated location of the article;
selecting a class of service for the article at the associated location;
selecting a carrier for the article at the associated location;
generating an article profile as a function of the article information, the class of service and the carrier; and
printing a label that includes the article profile information, wherein the printing is performed at the associated location.

2. The method of claim 1, further comprising:
transmitting the article profile information to an electronic storage medium.

3. The method of claim 1, further comprising:
transmitting the article profile information to a particular carrier location.

4. The method of claim 1, further comprising:
compiling manifest data as a function of a plurality of article profiles.

5. The method of claim 1, further comprising:
grouping the articles based on the selected carrier.

6. The method of claim 5, further comprising:
obtaining dimensional data from each article;
accumulating dimensional data as a function of the grouping step; and
transmitting the accumulated dimensional data to the selected carrier.

7. A packaging process, comprising:
transporting a portable package processing unit to a location of an article;
collecting information relating to the article;
selecting a class of service;
selecting a carrier from a plurality of carriers for shipment of the article;
printing a label for the article; and
grouping the article based on the selected carrier.

8. The process of claim 7, wherein the information relating to the article is selected from the group consisting of weight, destination address, origination address, mail class, and delivery date.

9. A portable apparatus for processing articles, comprising:
a portable scale unit adapted to establish a mass of a particular article;
a portable processing unit adapted to receive a mass input that is representative of the mass of the particular article, the portable processing unit having a user interface adapted to receive class of service input and carrier input;
the portable processing unit adapted to generate an output as a function of the mass of the particular article, a class of service for the particular article and a carrier for the particular article; and
a portable printer unit, coupled to the portable processing unit, adapted to receive as input, the output from the portable processing unit and the printer unit adapted to output data that is a function of the input received from the portable processing unit.

10. The apparatus of claim 9, further comprising:
a scanner unit adapted to establish dimensions of a particular article and transmit dimension data to the portable processing unit.

11. The apparatus of claim 9 wherein the scale is in electronic communication with the processing unit and the scale unit transmits the mass information to the processing unit.

12. The apparatus of claim 9, further comprising:
a wireless connection from the portable processing unit to a local server, the wireless connection adapted to transmit data from the portable processing unit to the local server.

13. The apparatus of claim 9, further comprising:
a wireless connection from the portable processing unit to a carrier location the, wireless connection adapted to transmit output from the processing unit to the carrier location.

14. An apparatus for processing articles, comprising:
means for collecting article information from each of a plurality of articles at an associated location of the article;
means for selecting a class of service for the article at the associated location;
means for selecting a carrier for the article at the associated location;
means for generating an article profile as a function of the article information, the class of service and the carrier; and
means for printing a label that includes the article profile information, wherein the printing is performed at the associated location.

15. The apparatus for processing articles of claim 14, further comprising:
means for transmitting the article profile information to an electronic storage medium.

16. The apparatus for processing articles of claim 14, further comprising:
means for transmitting the article profile information to a particular carrier.

17. The apparatus for processing articles of claim 14, further comprising:
means for compiling manifest data as a function of a plurality of article profiles.

18. The apparatus for processing articles of claim 14, further comprising:
means for grouping the articles based on the selected carrier.

19. The apparatus for processing articles of claim 18, further comprising:
means for obtaining dimensional data from each article;
means for accumulating dimensional data as a function of the grouping step; and
means for transmitting the accumulated dimensional data to the selected carrier.

20. A portable package processing unit adapted to be transported to a location of an article wherein the portable package processing unit is adapted to:
collect information relating to the article;
select a class of service;
select a carrier from a plurality of carriers for shipment of the article;
print a label for the article; and
group the article based on a selected carrier.

21. The portable package processing unit of claim 20, wherein the information relating to the article is selected from the group consisting of:
weight, destination, origination address, mail class, and delivery date.
